(19) United States
(12) Patent Application Publication
(10) Pub. No.: US 2025/0388144 A1
(43) Pub. Date: Dec. 25, 2025

(54) BACK FRAME

(71) Applicant: TOYOTA BOSHOKU KABUSHIKI KAISHA, Aichi (JP)

(72) Inventors: Yushi SHINOZAKI, Toyota-shi (JP); Yuya AKAI, Miyoshi-shi (JP)

(73) Assignee: TOYOTA BOSHOKU KABUSHIKI KAISHA, Aichi (JP)

(21) Appl. No.: 19/240,272

(22) Filed: Jun. 17, 2025

(30) Foreign Application Priority Data
Jun. 21, 2024 (JP) 2024-100262

(51) Int. Cl. B60N 2/68

(52) U.S. Cl. CPC B60N 2/682; B60N 2205/35

(57) ABSTRACT

To provide a back frame of a vehicle seat. A back frame of the present disclosure includes a first side frame, a second side frame, an upper frame, a lower frame, a first flange portion, a second flange portion, and a third flange portion. The first flange portion is provided on a rear end side of the first side frame and is joined to the lower frame. The second flange portion is located on a front side of the first flange portion in an outer edge of the first side frame and is joined to the lower frame. The third flange portion is provided in a predetermined range of the outer edge of the first side frame.

### CROSS-REFERENCE TO RELATED APPLICATIONS

The present application claims priority based on Japanese Patent Application No. 2024-100262 filed to Japanese Patent Office on Jun. 21, 2024, and the content of Japanese Patent Application No. 2024-100262 is incorporated by reference in its entirety.

### BACKGROUND

The present disclosure relates to a back frame of a vehicle seat.

For example, in the back frame described in Japanese Unexamined Patent Application Publication No. 2022-167380, two side frames, an upper frame, a lower frame, and the like constitute a frame-shaped frame. The frames are joined to each other by welding or the like.

### SUMMARY

The present disclosure discloses an example of a back frame capable of suppressing a decrease in strength while reducing joining defects of a side frame and a lower frame.

A back frame of a vehicle seat desirably includes, for example, at least one of the following components.

The components include a first side frame extending in a vertical direction, a second side frame disposed at a position shifted from the first side frame in a seat width direction, the second side frame extending in the vertical direction, an upper frame extending in the seat width direction and connecting an upper end side of the first side frame and an upper end side of the second side frame, a lower frame extending in the seat width direction and connecting a lower end side of the first side frame and a lower end side of the second side frame, a first flange portion provided on a rear end side of the first side frame and extending toward the second side frame, the first flange portion being joined to the lower frame, a second flange portion extending toward the second side frame from an outer edge of the first side frame located on a front side of the first flange portion, the second flange portion being joined to the lower frame, and a third flange portion extending toward the lower frame from an outer edge of the first side frame in a range from the first flange portion to the second flange portion, the third flange portion continuously extending toward the lower frame in a whole of the range.

As a result, in the back frame, for example, as compared with a configuration in which the first side frame and the lower frame are joined at three or more portions, the first side frame and the lower frame can be joined in a state where each of the first flange portion and the second flange portion is reliably in contact with the lower frame.

For example, in a case where there are three joint surfaces, it is difficult to join the three joint surfaces in a state where the joint surfaces are in contact with each other without any gap, due to accumulation of dimensional variations of the first side frame and the lower frame.

On the other hand, in the back frame, since the first side frame is joined to the lower frame at the first flange portion and the second flange portion, the influence of dimensional variations is reduced.

Therefore, each of the first flange portion and the second flange portion can be reliably brought into contact with the lower frame. As a result, each of the first flange portion and the second flange portion can be reliably joined to the lower frame.

However, in the configuration in which the first side frame is joined to the lower frame at the first flange portion and the second flange portion, rigidity and strength may be reduced as compared with the configuration in which the first side frame is joined to the lower frame at three portions.

In order to handle this, in the back frame, the third flange portion that is continuous in the range from the first flange portion to the second flange portion is provided. With such a configuration, even when the first side frame is joined to the lower frame at the first flange portion and the second flange portion, it is possible to ensure necessary rigidity and strength.

The back frame may have the following configuration. An extending dimension of the first flange portion and an extending dimension of the second flange portion are desirably larger than an extending dimension of the third flange portion. A joint surface of the first flange portion and the lower frame and a joint surface of the second flange portion and the lower frame are desirably planar surfaces. The joint portion of the second side frame and the lower frame may have the same configuration as the joint portion of the first side frame and the lower frame.

### BRIEF DESCRIPTION OF THE DRAWINGS

An example embodiment of the present disclosure will be described below with reference to the accompanying drawings, in which:

FIG. 1 is a diagram illustrating a back frame;

FIG. 2 is a diagram illustrating a joint portion of a first side frame and a lower frame;

FIG. 3 is an exploded diagram of the joint portion; and

FIG. 4 is a diagram illustrating the first side frame.

### DETAILED DESCRIPTION OF EXEMPLARY EMBODIMENTS

The following “embodiments of the present invention” illustrate examples of embodiments falling within the technical scope of the present disclosure. That is, the matters specifying the invention and the like described in the claims are not limited to the specific configurations, structures and the like described in the following embodiments.

The present embodiment is an example of a back frame of a seat (hereinafter, referred to as vehicle seat) mounted on a vehicle such as an automobile. Arrows indicating directions, oblique lines, and the like attached to the individual drawings are described in order to facilitate understanding of the relationship between the individual drawings, the shape of members or portions, and the like.

The back frame is not limited to the directions illustrated in the drawings. The directions illustrated in the individual drawings are directions in a state where the vehicle seat is assembled to a vehicle. The view with oblique lines does not necessarily show a cross-sectional view.

At least one member or portion described with at least a reference sign is provided unless otherwise noted such as “only one”. That is, when there is no description such as “only one”, two or more members may be provided. The back frame disclosed in the present disclosure includes at least one of components such as members or portions described with at least reference signs and structural portions shown in the drawings.

### First Embodiment

### <1. Outline of Back Frame>

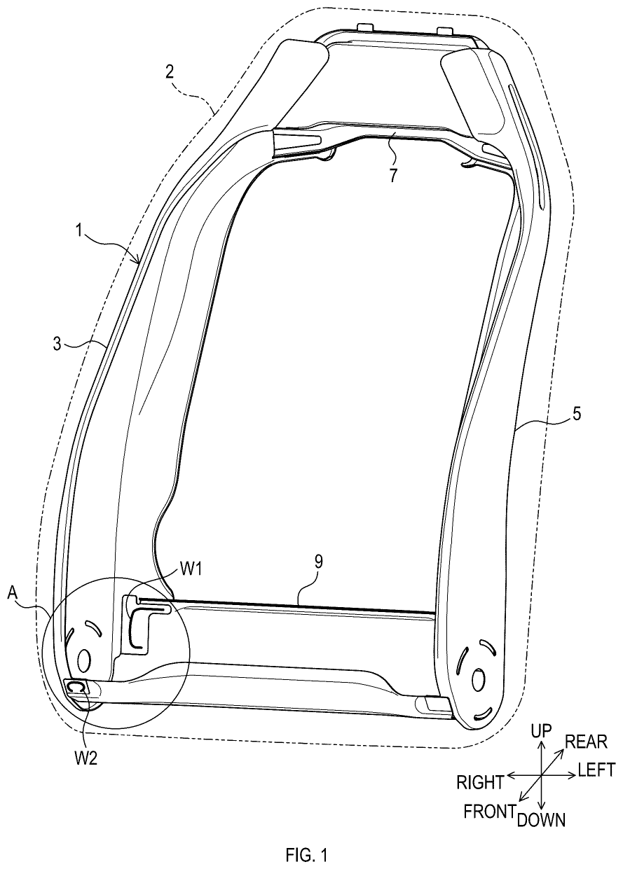

As illustrated in FIG. 1, a back frame 1 is a frame-shaped frame constituting the framework of a seat back 2. The seat back 2 is a portion for supporting the back of a sitter.

The back frame 1 includes a first side frame 3, a second side frame 5, an upper frame 7, and a lower frame 9. The first side frame 3 and the second side frame 5 are strength members extending substantially in the vertical direction.

The second side frame 5 is disposed at a position shifted from the first side frame 3 in a seat width direction (in FIG. 1, to the left side). The upper frame 7 is a strength member extending in the seat width direction and connecting the upper end side of the first side frame 3 and the upper end side of the second side frame 5.

The lower frame 9 is a strength member extending in the seat width direction and connecting the lower end side of the first side frame 3 and the lower end side of the second side frame 5. The first side frame 3, the second side frame 5, the upper frame 7, and the lower frame 9 are made of metal, and the frames are joined by laser welding.

### <2. Configuration of Joint Portion of Side Frame and Lower Frame>

The configuration of the joint portion of the first side frame 3 and the lower frame 9 is the same as the configuration of the joint portion of the second side frame 5 and the lower frame 9.

That is, these two configurations are substantially line-symmetric with respect to a virtual line crossing the center in the extending direction of the lower frame 9. The following description relates to the configuration of the joint portion (part A in FIG. 1) of the first side frame 3 and the lower frame 9.

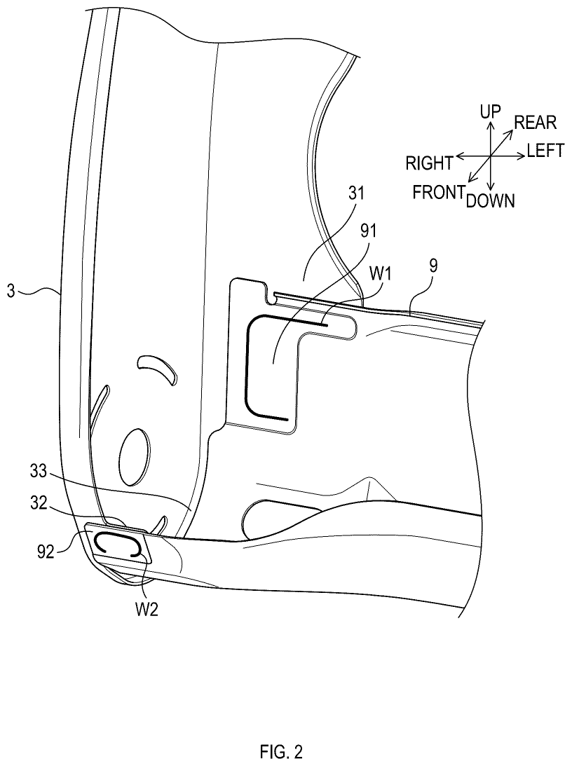

As illustrated in FIG. 2, the first side frame 3 and the lower frame 9 are joined to each other at least at two portions. Thick solid lines W1 and W2 illustrated in FIG. 2 indicate welding marks by laser welding.

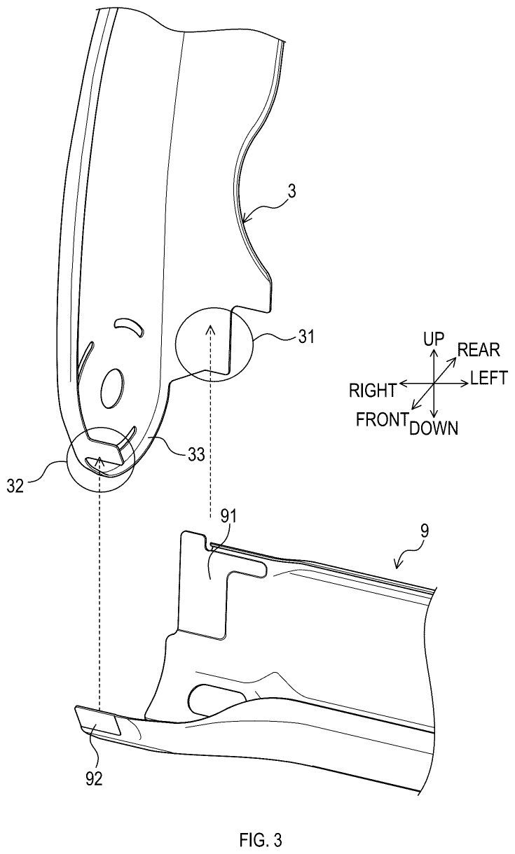

As illustrated in FIG. 3, a first flange portion 31, a second flange portion 32, and a third flange portion 33 are provided on the lower end side of the first side frame 3, that is, at a portion of the first side frame 3 joined to the lower frame 9.

The first flange portion 31 is a portion provided at the rear end of the first side frame 3 and extending toward the second side frame 5 (in the present embodiment, the left side). The first flange portion 31 is joined to a first joined portion 91 of the lower frame 9.

The second flange portion 32 is a portion extending toward the second side frame 5 (in the present embodiment, the left side) from the outer edge of the first side frame 3 located on the front side of the first flange portion 31. The second flange portion 32 is joined to a second joined portion 92 of the lower frame 9.

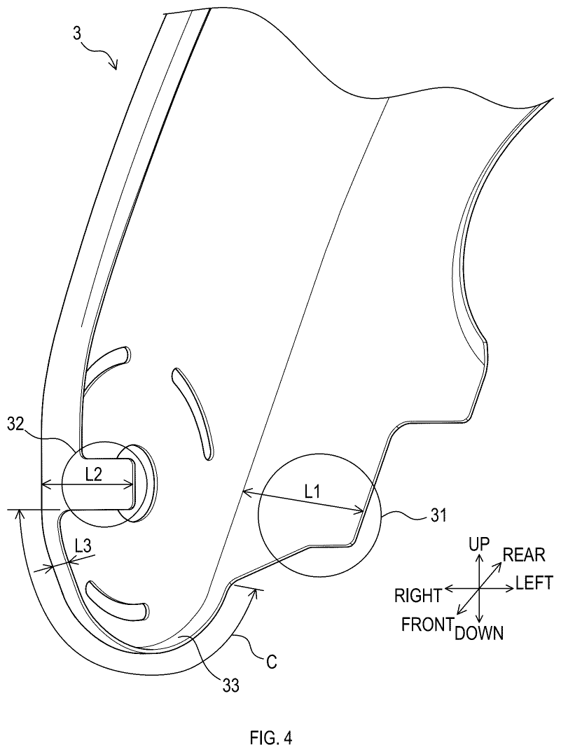

As illustrated in FIG. 4, the third flange portion 33 is a portion extending toward the lower frame 9 (in the present embodiment, the left side) from the outer edge of the first side frame 3 in a range C from the first flange portion 31 to the second flange portion 32.

The third flange portion 33 continuously extends toward the lower frame 9 (in the present embodiment, the left side) over the entire range C. An extending dimension L1 of the first flange portion 31 and an extending dimension L2 of the second flange portion 32 are larger than an extending dimension L3 of the third flange portion 33.

In addition, the joint surface of the first flange portion 31 and the lower frame 9 and the joint surface of the second flange portion 32 and the lower frame 9 are formed with planar surfaces. The first flange portion 31, the second flange portion 32, and the third flange portion 33 are integrally molded together with the first side frame 3 by applying plastic working such as press working to a steel plate.

### <3. Characteristics of Back Frame>

In the back frame 1, for example, as compared with a configuration in which the first side frame 3 and the lower frame 9 are joined at three or more portions, the first side frame 3 and the lower frame 9 can be joined in a state where each of the first flange portion 31 and the second flange portion 32 is reliably in contact with the lower frame 9.

For example, in a case where there are three joint surfaces, it is difficult to join the three joint surfaces in a state where the joint surfaces are in contact with each other without any gap, due to accumulation of dimensional variations of the first side frame 3 and the lower frame 9.

On the other hand, in the back frame 1, since the first side frame 3 is joined to the lower frame 9 at the first flange portion 31 and the second flange portion 32, the influence of dimensional variations is reduced.

Therefore, each of the first flange portion 31 and the second flange portion 32 can be reliably brought into contact with the lower frame 9. As a result, each of the first flange portion 31 and the second flange portion 32 can be reliably joined to the lower frame 9.

However, in the configuration in which the first side frame 3 is joined to the lower frame 9 at the first flange portion 31 and the second flange portion 32, rigidity and strength may be reduced as compared with the configuration in which the first side frame 3 is joined to the lower frame 9 at three portions.

In order to handle this, in the back frame 1, the third flange portion 33 that is continuous in the range C from the first flange portion 31 to the second flange portion 32 is provided. With such a configuration, even when the first side frame 3 is joined to the lower frame 9 at the first flange portion 31 and the second flange portion 32, it is possible to ensure necessary rigidity and strength.

### OTHER EMBODIMENTS

In the embodiment described above, the first side frame 3 and the lower frame 9 are joined by laser welding. However, the present disclosure is not limited thereto. For example, the first side frame 3 and the lower frame 9 may be joined with an adhesive.

In the embodiment described above, the vehicle seat according to the present disclosure is applied to a vehicle. However, the application of the invention disclosed herein is not limited thereto. For example, the present invention can also be applied to seats used for vehicles such as railway vehicles, ships, and aircrafts, and stationary seats used in theaters, homes, and the like.

Furthermore, the present disclosure is not limited to the embodiments described above as long as it meets the gist of the disclosure described in the embodiments. Therefore, a configuration in which at least two of the plurality of embodiments described above are combined, or a configuration in which any of the components illustrated in the drawings or the components described with reference signs in the embodiments is eliminated may be used.

What is claimed is:

1. A back frame of a vehicle seat, comprising:
a first side frame extending in a vertical direction;
a second side frame disposed at a position shifted from the first side frame in a seat width direction, the second side frame extending in the vertical direction;
an upper frame extending in the seat width direction and connecting an upper end side of the first side frame and an upper end side of the second side frame;
a lower frame extending in the seat width direction and connecting a lower end side of the first side frame and a lower end side of the second side frame;
a first flange portion provided on a rear end side of the first side frame and extending toward the second side frame, the first flange portion being joined to the lower frame;
a second flange portion extending toward the second side frame from an outer edge of the first side frame located on a front side of the first flange portion, the second flange portion being joined to the lower frame; and
a third flange portion extending toward the lower frame from an outer edge of the first side frame in a range from the first flange portion to the second flange portion, the third flange portion continuously extending toward the lower frame in a whole of the range.

2. The back frame according to claim 1, wherein an extending dimension of the first flange portion and an extending dimension of the second flange portion are larger than an extending dimension of the third flange portion.

3. The back frame according to claim 1, wherein a joint surface of the first flange portion and the lower frame and a joint surface of the second flange portion and the lower frame are planar surfaces.
